(19) United States
(12) Patent Application Publication
(10) Pub. No.: US 2023/0185209 A1
(43) Pub. Date: Jun. 15, 2023

(54) RESIN PARTICLE, TONER, TONER ACCOMMODATING UNIT

(71) Applicants: Kazuoki FUWA, Shizuoka (JP); Kohsuke SATOH, Shizuoka (JP); Toshihiko SUGIYAMA, Shizuoka (JP); Natsuko MATSUSHITA, Shizuoka (JP)

(72) Inventors: Kazuoki FUWA, Shizuoka (JP); Kohsuke SATOH, Shizuoka (JP); Toshihiko SUGIYAMA, Shizuoka (JP); Natsuko MATSUSHITA, Shizuoka (JP)

(21) Appl. No.: 18/070,507

(22) Filed: Nov. 29, 2022

(30) Foreign Application Priority Data
Dec. 9, 2021 (JP) 2021-200285

(51) Int. Cl. G03G 9/087

(52) U.S. Cl. CPC G03G 9/08755

(57) ABSTRACT

A resin particle contains resin containing a tetrahydrofuran insoluble portion containing a non-linear polymer in which a non-linear prepolymer is cross-linked with a metal ion,
wherein the resin particle has a carbon-14 concentration of 5.4 pMC or greater,
wherein the tetrahydrofuran insoluble portion has a glass transition temperature of from −60 to lower than 0 degrees C. as measured by differential scanning calorimetry.

### CROSS-REFERENCE TO RELATED APPLICATIONS

This patent application is based on and claims priority pursuant to 35 U.S.C. § 119 to

Japanese Patent Application No. 2021-200285, filed on Dec. 9. 2021, in the Japan Patent Office, the entire disclosure of which is hereby incorporated by reference herein.

### BACKGROUND

### Technical Field

The present disclosure is related to a resin particle, toner, and a toner accommodating unit.

### Description of the Related Art

Resin particles used as toner are required to be less burden on the environment. Reducing the amount of energy consumed in a manufacturing process and adopting plant-derived resin for binder resin have been attempted.

However, such a plant-derived resin lowers the strength of toner, causing drawbacks such as filming.

### SUMMARY

According to embodiments of the present disclosure, a resin particle is provided which contains resin containing a tetrahydrofuran insoluble portion containing a non-linear polymer in which a non-linear prepolymer is cross-linked with a metal ion,

wherein the resin particle has a carbon-14 concentration of 5.4 pMC or greater,

wherein the tetrahydrofuran insoluble portion has a. glass transition temperature of from −60 to lower than 0 degrees C. as measured by differential scanning calorimetry.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG 1 is a schematic diagram illustrating an example of an image forming apparatus using an embodiment of the present invention; and

FIG. 2 is a schematic diagram illustrating an example of a process cartridge using an embodiment of the present invention.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to he understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, a resin particle containing plant-derived resin is provided which can be manufactured with less manufacturing energy and less additional materials while having an excellent low temperature fixability without an adverse impact on the strength.

The resin particle of the present disclosure used as toner is described below.

One known way of reducing the amount of energy consumed during manufacturing toner is to prepare a polymerization toner. One way of reducing additional materials is a. phase-transfer emulsification, where a minor amount of a surfactant is used.

Adding a gel portion to toner is suitable to minimize the degradation of the strength of resin particles when a plant-derived resin is used. However, in the case of a polymerization toner, adding a gel portion to a material of toner is difficult because the resin is required to be dissolved or fine-dispersed in advance.

One known way of preparing a polymerization toner containing a gel portion is to elongate an isocyanate-terminated prepolymer during or after granulation. However, according to an investigation by the inventors of the present invention, toner prepared in the method such as phase-transfer emulsification in which toner is made via fine particles fails to contain a sufficient amount of gel portion because the prepolymers do not elongate sufficiently.

Based on this finding, the inventors reviewed this drawback and have found that a combinational use of a polymerization toner and plant-derived resin as a way of preparing toner containing a. gel portion is made practical by containing a tetrahydrofuran (THF) insoluble portion, a portion insoluble to THF, elongated by metal cross-linking the terminal of a prepolymer having a functional group allowed to salt bridge.

An unlimited inclusion of a THF insoluble portion degrades the low temperature fixability, resulting in an increase in the amount of energy consumed during fixing.

However, a Tg of the THF insoluble portion of from −60 to lower than 0 degrees C. reduces the amount of energy used for fixing.

Based on this knowledge, the inventors of the present invention have formulated a resin particle having a carbon-14 concentration of 5.4 pMC or greater and containing a. 5 tetrahydrofuran insoluble portion containing a non-linear polymer in which a non-linear prepolymer is cross-linked with a. metal ion, wherein the tetrahydrofuran insoluble portion has a glass transition temperature of from −60 to lower than. 0 degrees C. as measured by differential scanning calorimetry.

The resin particle of the present disclosure is described in detail.

Resin Particle

The resin particle has a radiocarbon ¹⁴C concentration (hereinafter referred to as carbon-14 concentration) of 5.4 pMC or greater and preferably 10.8 pMC or greater.

pMC is percent modern carbon, which is a unit representing carbon-14 concentration, it represents a ratio in percent of the carbon-14 concentration of a target sample to the carbon-14 concentration of the reference sample dated 1950 in the western calendar as 100 percent.

When the carbon-14 concentration is less than 5.4 pMC, the degree of biomass is low, failing to achieve the objectives of the present disclosure.

There is a relationship between carbon-14 concentration and the degree of biomass.

Carbon-A concentration (pMC) =degree of biomass (percent)/0.935

When the carbon-14 concentration is 5.4 pMC or greater, the degree of biomass is 5 percent or greater, which is demanded from a carbon neutral point of view. Carbon-14 concentration is preferably 20 percent or greater and more preferably 40 percent or greater.

Carbon-14 concentration is to define how much amount of plant-derived carbon is present in the entire carbon element components in a petroleum product containing carbon. Carbon-14 concentration in carbon element in a petroleum product can be measured according to ASTM-D6866, one of American Society for Testing and Materials (ASTM) Standards.

Carbon-14 is present in the natural world (atmosphere), taken inside a plant through photosynthesis while the plant is active, and it is the equilibrium concentration (107.5 pMC) of carbon-14 concentration of CO₂ in atmosphere and carbon-A concentration in carbon in organic components in plants.

Carbon is not taken in a plant any more when the plant ceases to be alive. Then carbon-14 concentration decreases according to the radioactive half life of 5730 years of carbon-14.

Carbon-14 is little detected from fossil resources originated from life forms because ten thousand to hundred million years have passed since the live forms died.

The resin particle of the present disclosure contains a releasing agent and a coloring 5 material in addition to the resin when the particle is used as a mother toner particle.

One way of increasing carbon-14 concentration of a resin particle is to use plant-origin materials for the resin such as amorphous resin and crystalline resin and a releasing agent.

The components constituting the resin particle are described below.

Resin

As the resin, amorphous resin and crystalline resin can be used.

Amorphous Resin

The THF insoluble portion is an amorphous resin. This portion is described in THF Insoluble Portion later.

The amorphous resin preferably includes an amorphous polyester resin advantageous to achieve excellent low temperature fixability. Of these, linear polyester resin is preferable. In addition, unmodified polyester resin is preferable.

The unmodified polyester resin is obtained by using a polyol and a polycarboxylic acid, polycarboxylic anhydride, and polycarboxylic acid ester and their derivatives. These are polyester resins not modified with a substance such as an isocyanated compound.

The amorphous polyester resin does not preferably have a urethane bonding or urea bonding.

The amorphous polyester resin contains a dicarboxylic acid component, which preferably contains terephthalic acid in an amount of 50 mol percent or greater. This proportion is advantageous in terms of high temperature storage stability.

This amorphous polyester resin is also referred to as amorphous polyester resin B. The crystalline polyester resin, which is described layer, is also referred to as crystalline polyester resin C. The amorphous polyester resin derived from prepolymer, which is described later, is also referred to as amorphous polyester resin A.

One of the polyols is a diol.

Specific examples of diol includes, but are not limited to, an adduct of bisphenol A with alkylene (having two or three carbon atoms) oxide (average adduction number of cools of from 1 to 10) such as polyoxypropylene(2,2)-2,2-bis(4-hydroxyphenyl)proparie, polyoxyethylene(2,2)-2,2-bis(4-hydroxyphenyl)propane, ethylene glycol and propylene glycol, hydrogenated bisphenol A, and an adduct of hydrogenated bisphenol A with an alkylene (having two or three carbon atoms) oxide (average adduction number of mots of from 1 to 10).

These can be used alone or in combination.

A specific example of the polycarboxylic acid is dicarboxylic acid.

Specific examples of dicarboxylic acid include, but are not limited to, adipic acid, phthalic acid, isophthalic acid, terephthalic acid, funtaric acid, maleic acid, and succinic acid substituted with an alkyl group having 1 to 20 carbon atoms or alkenyl group having 2 to 20 carbon atoms such as dodecenyl succinic acid and octyl succinic acid.

Of these, dicarboxylic acid containing a succinic acid of saturated aliphatic series derived from a plant is preferable.

The level of carbon neutral becomes high because of its being plant-origin. Saturated aliphatic series enhances recrystallization of crystalline polyester resin, increases the aspect ratio of the crystalline polyester resin, and ameliorates the low temperature fixability.

These can be used alone or in combination.

The amorphous polyester resin B may optionally contain at least either of a tri- or higher carboxylic acid or a tri- or higher alcohol to adjust the acid value and hydroxyl value.

Specific examples of tri- or higher carboxylic acid include, but are not limited to, trimellitic acid, pyromellitic acid, and their anhydrides.

Specific examples of tri- or higher alcohol include, but are not limited to, glycerin, pentaerythritol, and trimethylol propane.

The molecular weight of the amorphous polyester resin B is not particularly limited and can be suitably selected to suit to a particular application. The weight average molecular weight (Mw) is preferably from 3,000 to 10,000 as measured by gel permeation chromatography (GPC). The number average molecular weight (Mn) is preferably from L000 to 4,000. The ratio of Mw/Mn is preferably from 1.0 to 4.0.

A molecular weight of the lower limit mentioned above or higher prevents the high temperature storage stability and the durability to stress such as stirring in a developing device of a resin particle from lowering. A molecular weight up to the upper limit mentioned above prevents the viscoelasticity during melting of a resin particle from increasing and the low temperature fixability thereof from lowering.

The weight average molecular weight (Mw) is more preferably from 4,000 to 7,000. The number average molecular weight (Mn) is more preferably from 1,500 to 3,000. The ratio of Mw/Mn is more preferably from 1.0 to 3.5.

The acid value of the amorphous polyester resin B is not particularly limited and can be suitably selected to suit to a particular application. The acid value is preferably from 1 to 50 mgKOHIg and more preferably from 5 to 30 mgKOR/g. An acid value of I mgKOH/g or greater tends to negatively charge a resin particle and enhances the affinity between paper arid the resin particle during fixing on the paper, enhancing the low temperature fixability. An acid value of 50 mgKOH/g or less prevents the charging stability, particularly charging stability to environmental fluctuation, from deteriorating.

The hydroxyl value of the amorphous polyester resin B is not particularly limited and can be suitably selected to suit to a particular application. The value is preferably 5 mgKOH/g or greater.

The glass transition temperature (Tg) of the amorphous polyester resin is preferably from 40 to 80 degrees C. and more preferably from 50 to 70 degrees C. A glass transition temperature of 40 degrees C. or higher enhances the high temperature storage stability and the durability to stress such as stirring in a developing device while enhancing the resistance to filming. .A glass transition temperature of 80 degrees C. or lower suitably transforms the shape of resin particles by heating and pressure during fixing, thereby enhancing the low temperature fixability.

The molecular structure of the amorphous polyester resin B can be confirmed by measuring a solution or solid by methods such as NMR, X ray diffraction, GC/MS, LC/MS, and infrared (IR) absorption measuring. Amorphous polyester resin can be simply detected as a substance that does not have absorption in 965 ±10 cm⁻¹ based on δCH

The content of the amorphous polyester resin B is not particularly limited and can be suitably selected to suit to a particular application. The number of parts of the amorphous polyester resin B to 100 parts by mass of the resin particle mentioned above is preferably from 50 to 90 parts by mass and more preferably from 60 to 80 parts by mass. A number of parts of 50 parts by mass or greater reduces the deterioration of the dispersibility of a pigment and releasing agent in a resin particle and minimizes fogging and disturbance of an image. A number of parts of 90 parts by mass or less prevents a decrease in the content of the crystalline polyester resin C and that of the amorphous polyester resin A and deterioration of the low temperature fixability. When the content is in the more preferable region, the resin particle is excellent regarding the image quality and low temperature fixability.

Crystalline Resin

The resin particle of the present disclosure preferably includes a crystalline resin as an additive to enhance the low temperature fixability.

The crystalline resin is not particularly limited as long as it has crystallinity and can be suitably selected to suit to a particular application. The crystalline resin includes, for example, polyester resin, polyurethane resin, polyurea. resin, polyamide resin, polyether resin, vinyl resin, and modified crystalline resin. These can be used alone or in combination.

The crystalline polyester resin C is described below.

Crystalline Polyester Resin C

The crystalline polyester resin C is prepared by a polyol with a polycarboxylic acid including a. polycarboxylic anhydride and polycarboxylic acid ester or their derivatives. In the present disclosure, the crystalline polyester resin C refers to a substance obtained by using a polyol and a polycarboxylic acid including a polycarboxylic anhydride and polycarboxylic acid ester or their derivatives as described above The crystalline polyester resin C excludes modified polyester resin obtained by prepolymer and resin obtained by cross-linking andlor elongating the prepolymer.

Polyol

The polyol or polyhydric alcohol is not particularly limited and can be suitably selected to suit to a particular application. Examples include, but are not limited to, diol and tri- or higher alcohols. One example of diol is saturated aliphatic diol. Saturated aliphatic diol includes straight chain saturated aliphatic diol and branch-chain saturated aliphatic diol. Of these, straight-chain saturated aliphatic diol is preferable and straight-chain saturated aliphatic diol having 2 to 12 carbon atoms is more preferable. If saturated aliphatic diol is of a branch type, the crystallinity of the crystalline polyester resin C deteriorates, which may lead to a drop of the melting point thereof. Practical saturated aliphatic diol having 13 or more carbon atoms is not readily available.

Specific examples of the saturated aliphatic diol include, but are not limited to, ethylene glycol, 1,3-propanediol, 1,4-hutanediol, 1,5-pentanediol, 1,6-hexanediol, heptanediol, 1,8 -octanediol, 1,9-nonanediol, 1,10-decanediol, 1,11-undecanediol, 1,12-dodecanediol, 1,13-tridecanediol, 1,14-tetradecanediol, 1,18-octa.decanediol, and 1,14-eicosandecanediol. Of these, ethylene glycol, 1,4-hutanediol, 1,6-hexanediol, 1,8-octanediol, 1,9-nonanediol, 1,10-decanediol, and 1,12-dodecanediol are preferable to enhance the crystallinity of crystalline polyester resin C and achieve excellent sharp melting thereof.

Specific examples of the tri- or higher alcohol having include, but are not limited to, glycerin, trimethylol ethane, trimethylol propane, and pentaerythritol. These may be used alone or in combination of two or more thereof.

Polycarboxylic Acid Component

The polycarboxylic acid is not particularly limited and can be suitably selected to suit to a particular application. Examples include, but are not limited to, dicarboxylic acid and tri- or higher carboxylic acid.

Specific examples of dicarboxylic acids include, but are not limited to, saturated aliphatic dicarboxylic acid such as oxalic acid, succinic acid, alutaric acid, adipic acid, suberic acid, azelaic acid, sebacic acid, 1,9-nonan dicarboxylic acid, 1,10-decade dicarboxylic acid, 1,12-dodecane dicarboxylic acid, 1,14-tetradecane dicarboxylic acid, and 1,18-octadecane dicarboxylic acid and aromatic dicarboxylic acids such as phthaiic acid, isophthaiic acid, terephthalic acid, naphthalene-2,6-dicarboxylic acid, malonic acid, and mesaconic acid. They include anhydrides or lower alkylesters (1 to 3 carbon atoms) thereof.

Plant-derived saturated aliphatic having 12 or less carbon atoms is preferable from a carbon neutral point of view.

Specific examples of the tri- or higher carboxylic acids include, but are not limited to, 1,2,4-benzene tricarboxylic acid, 1,2,5-benzene tricarboxylic acid, 1,2,4-naphtalene tricarboxylic acid, and their anhydrides or lower alkyl esters (1 to 3 carbon atoms).

These may be used alone or in combination of two or more thereof.

The crystalline polyester resin C is preferably formed of a straight chain aliphatic dicarboxylic acid having 4 to 12 carbon atoms and a straight chain saturated aliphatic diol having 2 to 12 carbon atoms. The crystalline polyester resin C has thus high crystallinity and excellent sharp melting, thereby demonstrating an excellent low temperature fixability.

One way of controlling the crystallinity and the softening point of the crystalline polyester resin C is to design and use a non-linear polyester obtained through polycondensation in which, during polyesterization, polyol including tri- or higher alcohol such as glycerin is added to the alcohol component and polycarboxylic acid including tri or higher carboxylic acid such as trimellitic anhydride is added.

The molecular structure of the crystalline polyester resin C can be confirmed by measuring a solution or solid by methods such as NMR, X ray diffraction, GC/MS, LC/MS, and infrared (IR) absorption measuring.

The crystalline polyester resin C can be simply detected as a substance that has 0 absorption in the range of 965±10 cm⁻¹ based on δCH (out of plane bending vibration) of olefin in an infrared absorption spectrum.

Based on the knowledge about the molecular weight that resin having a low molecular weight and a sharp molecular weight distribution has a good low temperature fixa.bility and resin containing a component having a small molecular weight in a large amount has a poor high temperature storage stability, the inventors of the present invention have found that the molecular weight of the crystalline polyester resin C preferably has a peak in a range of from 3.5 to 4.0, a peak half width value of 1.5 or less, a weight average molecular weight (Mw) of from 3,000 to 30,000, a number average molecular weight (Mn) of from 1,000 to 10,000, and an Mw/Mn of from I to 10 in the graph of the molecular weight distribution due to gel permeation chromatography (GPC) of a portion soluble in o-dichiorobenzene with an X axis of log (M) and an Y axis of a molecular weight represented in percent by mass.

The weight average molecular weight (Mw) is more preferably from 5,000 to 15,000, the number average molecular weight (Mn) is more preferably of from 2,000 to 10,000, and the ratio of Mw/Mn_{—} is more preferably from I to 5.

The acid value of the crystalline polyester resin C is preferably 5 mgKOH/g or more to achieve a target low temperature fixability in terms of the affinity between paper and resin and more preferably 7 trigKOH/g or more to manufacture fine particles by a phase-transfer emulsification. On the other hand, it is preferably 45 ingKOH/g or less to enhance the hot offset property. The hydroxyl value of a crystalline polymer is preferably from 0 to 50 ingKOH/g and more preferably from 5 to 50 ingKOH/g to achieve a target low temperature fixability and good chargeability.

THF Insoluble Portion

The THF insoluble portion refers to a component having a large molecular weight in some degree and insoluble in THF.

THF insoluble portion includes a non-linear polymer having at least three branches formed of non-linear prepolymer cross-linked with metal ions and other components having a large molecular weight in some degree. The other components include non-branched linear polymers.

The non-linear polymer has a glass transition temperature Tg of −60 to lower than 0 degrees C. as measured by differential scanning calorimetry (DSC). The glass transition temperature Tg of the non-linear polymer as measured by DSC is preferably Tg2n.d of the second temperature rising by DSC. Since a non-linear polymer is amorphous, there is no large difference between the glass transition temperature Tglst of the first temperature rising by DSC and the Tg2nd. However, since the glass transition temperature Tg of a non-linear polymer is generally heated and measured in bulk, the non-linear polymer at Tg1st contains air, which may increase an error or noise. At the Tg2nd, the non-linear polymer little contains air so that the glass transition temperature can be stably measured without an error or noise.

As described above, the non-linear polymer in the resin particle of the present disclosure is metal cross-linked with metal ions. This polymer forms gel, insoluble to THF. The glass transition temperature of non-linear polymers in the resin particle of the present disclosure can be confirmed by measuring the glass transition temperature of the THF insoluble portion in the resin particle.

The THF insoluble portion of the resin particle of the present disclosure is obtained by a dissolution filtering or a method of obtaining extracted residual using a typical soxhlet extraction. Either method is suitable. In the present disclosure, the THF insoluble portion is obtained by the dissolution filtering described below.

One gram of resin particles is weighed and charged in 100 mL of THF, followed by stirring with a stirrer at 25 degrees C. for six hours to obtain a solution in which the soluble portion of the resin particle is dissolved. Then the solution is filtered with a 0.2 μm membrane filter. The filtrate obtained is placed in 50 mL THF again and stirred with a stirrer for 10 minutes. After repeating this operation twice or three times, the filtrate obtained is dried at 120 degrees C. under 10 kPa or less to obtain a TMF insoluble portion. In the case of soxhlet extraction, preferably I pan of resin particle placed in 100 parts of THF is held at reflex for 6 hours or more to separate the THF insoluble portion from the soluble portion.

The proportion of the THF insoluble portion to the resin particle is preferably from 15 to 40 percent by mass and more preferably from 20 to 35 percent by mass. A THF insoluble portion having a proportion of 15 percent by mass or more compensates the deterioration of the strength attributable to a plant-derived resin. The degree of plant can be raised by increasing the amount of THF insoluble portion. A THF insoluble portion having a proportion of 40 percent by mass or less is preferable because it does not degrade the high temperature storage stability.

The proportion of the THF insoluble portion in the resin particle of the present disclosure can be measured by weighing the THF insoluble portion in the resin particle obtained by soxhlet extraction with an electronic scale and obtained by the following relationship: {THF insoluble portion (g)/Amount (g) of resin particle before extraction}×100.

The non-linear polymer is obtained by the reaction between a non-linear reactive precursor (hereinafter referred to as prepolymer in the present disclosure) and a metal ion.

The metal cross-linking of a non-linear polymer is formed of a metal ion of a metal salt and free of urea and urethane groups, resulting in achieving a good chargeability.

Non-linear Prepolymer

The non-linear prepolymer is not particularly limited and can be suitably selected to suit to a particular application as long as it is polyester having a group reactive with a metal

One example of the groups reactive with the metal ion in a prepolymer is carboxylic acid.

The prepolymer is non-linear. Non-linear refers to a branched structure attributed by at least one of tri- or higher alcohol and tri- or higher carboxylic acid.

This tri- or higher alcohol is not particularly limited and can be suitably selected to suit to a particular application. It includes a tri- or higher aliphatic alcohol, a tri- or higher polyphenol, and an adduct of polyphenol with alkylene oxide.

Specific examples of tri- or higher aliphatic alcohol include, but are not limited to, glycerin, trimethylol ethane, trimethylol propane, pentaerythritol, and sorbitol.

Specific examples of ti- or higher polyphenol include, but are not limited to, trisphenol PA, phenol novolac, and cresol novolac.

Specific examples of the adduct of polyphenols with tri.- or higher alkylene oxide include, but are not limited to, an adduct of tri- or higher polyphenol with alkylene oxide such as ethylene oxide, propylene oxide, and butylene oxide.

Tri- or higher carboxylic acid is not particularly limited and can be suitably selected. to suit to a particular application. It includes tri- or higher aromatic carboxylic acid. These anhydrides, lower (1 to 3 carbon atoms) alkylester compounds, or halogenated compounds can be used.

Tri- or higher aromatic carboxylic acid preferably has 9 to 20 carbon atoms.

Specific examples of tri- or higher aromatic carboxylic acid having 9 to 20 carbon atoms include, but are not limited to, trimellitic acid and pyromellitic acid.

Coloring Agent

Suitable colorant (coloring material) include known dyes and pigments.

Specific examples include, but are not limited to, carbon black, Nigrosine dyes, black iron oxide, Naphthol Yellow S, Hansa. Yellow (10G, 5G and G), Cadmium Yellow, yellow iron oxide, loess, chrome yellow, Titan Yellow, poly azo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Faise Red, p-chloro-o-nitroaniline red, Lithol Fast Scarlet G, Brilliant Fast Scarlet, Brilliant Carmine BS, Permanent Red (F2R., F4R, FRL, FRLL and F4RH), Fast Scarlet VD, Vulcan

Fast Rubino B, Brilliant Scarlet G, Lithol Rubino GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamin.e Lake Y, Alizarine Lake:, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone BlueFast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials can be used alone or in combination.

Charge Control Agent

Additives such as a charge control agent can be added to an oil phase.

Specific examples of the charge control agent include but are not limited to, known charge control agents such as Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, and metal salts of salicylic acid derivatives.

Specific examples of the procurable charge control agents include, but are not limited to, BONTRON 03 (Nigrosine dyes). BONTRON P-51 (quaternar ammonium salt), BONTRON 5-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternaiy ammonium salt), COPY BLUE (triphenyl methane derivative), COPY CHARGE NEG VP2036 and NX VP434 (quatemary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers haying a functional group such as a sulfonate group, a. carboxyl group, and a quaternary ammonium group. The charge control agent is used in an amount within a range in which the charge control agent demonstrates its capability without an adverse impact on the fixability. Its proportion to a resin particle is preferably from 0.5 to 5 percent by mass or less and more preferably from 0.8 to 3 percent by mass.

Wax.

Wax is not particularly limited and can be suitably selected to suit to a particular application. For example, a releasing agent having a low melting point of from 50 to 120 degrees C. is preferable. By dispersing a releasing agent having such a low melting point with the resin mentioned above, it works efficiently at the interface between a fixing roller and the resin particle. For this reason, hot offset resistance is good even in an oil-free configuration (in which a releasing agent like oil is not applied to a fixing roller).

Waxes are preferably used as the releasing agent. Specific examples of such waxes include, but are not limited to, natural waxes including: plant waxes such as carnauba wax, cotton wax, vegetable wax, and rice wax; animal waxes such as bee wax and lanolin; mineral waxes such as ozokerite; and petroleum waxes such as paraffin, microcrystalline, and petrolatum. In addition to these natural waxes, synthesis hydrocarbon waxes such as Fischer-Tropsch wax and polyethylene wax and synthesis wax such as ester, ketone, and ether are also usable, Furthermore, aliphatic acid amide such as 2-hydroxystearic acid amide, steari.c acid. amide, phthaiic acid anhydride imide, and chlorinated hydrocarbons; crystalline polymer resins having a low molecular weight such as homo polymers, for example, poly-n-stearylic tnethacrylate and poly-n-lauryl methacrylate, and copolymers (for example, copolymers of n-stearyl acrylate-ethylmethacrylate); and crystalline polymer having a long alkyl group in the branched chain are also usable. These can be used alone or in combination.

Plant-derived wax is preferable in a carbon-neutral point of view

The melting point of wax is not particularly limited and can be suitably selected to suit to a particular application. The melting point is preferably from 50 to 120 degrees C. and more preferably from 60 to 90 degrees C. A melting point of wax of 50 degrees C. or higher prevents an adverse impact of wax on the high temperature storage stability and a melting point of 120 degrees C. or lower prevents cold offset at low temperatures during fixing. The melt-viscosity of wax is preferably from 5 cps to 1,000 cps and more preferably from 10 cps to 100 cps at a temperature 20 degrees C. higher than the melting point of the wax (releasing agent). A melt-viscosity of 5 cps or more prevents the degradation of the relasability. A melt-viscosity of 1,000 cps or less will suffice to demonstrate the hot offset resistance and low temperature fixability of a releasing agent. The proportion of wax to the resin particle mentioned above is not particularly limited and can be suitably selected to suit to a particular application. For example, it is preferably from 0 to 40 percent by mass and more preferably from 3 to 30 percent by mass. A proportion of 40 percent by mass or less prevents the degradation of flowability of the resin particle.

Method of Manufacturing Resin Particle

One way of manufacturing a resin particle is to employ a known emulsification agglomeration method. One method of manufacturing the resin particle of the present disclosure is described below.

In this method, resin particles are obtained by preparing an aqueous medium, preparing an oil phase containing a resin particle material, adding the oil phase to the aqueous medium to obtain an oil-in water liquid dispersion (i.e., phase transfer emulsification), purging the oil-in water liquid dispersion of the organic solvent to obtain a liquid dispersion of fine particles, aggregating the liquid dispersion of fine particles, fusing the aggregated particles, and rinsing and drying the resin particles obtained in the fusing. Toner is obtained by mixing the resin particle obtained as described above with an external additive.

Preparing Aqueous Medium

The aqueous medium is not particularly limited and can be suitably selected to suit to a particular application. It includes, for example, water, a solvent miscible with water, and a mixture thereof. These can be used alone or in combination. Of these, water is preferable.

The solvent miscible with water is not particularly limited and can be suitably selected to suit to a particular application. it includes, for example, alcohol, dimethyl fortnamide, tetrahydrofuran, cellosolves, and lower ketones.

Alcohol is not particularly limited and can be suitably selected to suit to a particular application. It includes, for example, methanol, isopropanol, and ethylene glycol.

Lower ketones are not particularly limited and can be suitably selected to suit to a. particular application. It includes, for example, acetone and methylethyl ketone.

Preparing Oil Phase

An oil phase is prepared in which substances such as resin, a colorant, a prepolyrner, and wax are dissolved or dispersed in an organic solvent. Specifically, substances such as resin and a colorant are slowly added to an organic solvent during stirring to dissolve or disperse them in the solvent. For dispersion, known devices such as a bead mill or disk mill can be used.

Organic Solvent

This organic solvent is preferably a volatile organic solvent having a boiling point lower than 100 degrees C. to readily remove the organic solvent later.

Specific examples of the organic solvent include, but are not limited to, toluene, xylene, benzene, carbon tetrachloride, methylene chloride, 1,2-dichloroethane, 1,1,2-trichloroethane, trichloroethylene, chloroform, monochlorobenzene, di chloroethylidene, methyl acetate, ethyl acetate, methylethyl ketone, methylisobuthyl ketone, methanol, ethanol, and isopropyl alcohol. These can he used alone or in combination. A resin having a polyester backbone is well dissolved or dispersed in an organic solvent such as ester-based solvents including methyl acetate, ethyl acetate, and butyl acetate or ketone-based solvents including tnethylethyl ketone and methyl isobutyl ketone. Of these, methyl acetate, ethyl acetate, and methyl ethyl ketone are particularly preferable to readily purge a dispersion of the organic solvent later.

Phase-transfer Emulsification

A liquid dispersion of fine particles in which microparticulated oil phase is dispersed in an aqueous medium is obtained in the phase-transfer emulsification.

The way of phase-transfer emulsification is not particularly limited and can be suitably selected to suit to a particular application. One way is to neutralize an oil phase with a substance such as a base followed by adding the aqueous phase mentioned above to the neutralized phase to transfer the phase from the water-in oil liquid dispersion to the oil-in-water liquid dispersion, thereby obtaining a liquid dispersion of fine particles.

The base for neutralizing the oil phase mentioned above is not particularly limited and can be suitably selected to suit to a particular application. It includes, for example, sodium hydroxide, potassium hydroxide, and ammonium water.

Removing Solvent

The solvent is removed from the liquid dispersion of fine particles obtained as described above in the removing solvnet process.

One way of removing an organic solvent from the thus-prepared liquid dispersion of fine particles is to completely evaporate and remove the organic solvent in liquid droplets by gradually raising the temperature of the entire system,

Alternatively, it is possible to evaporate and remove an organic solvent by reducing the pressure applied to the liquid dispersion of fine particles during stirring.

Aggregation

Next, the liquid dispersion of fine particles obtained is aggregated to have a target particle size while the dispersion is stirred.

It is preferable to add a metal ion during the aggregation to metal cross-link non-linear prepolymers, thereby to produce a non-linear polymer as a cross-linking component.

Metal Ion

The metal ion serves as a cross-linking agent for cross-linking the terminals of non-linear prepolymers. The metal ion preferably includes two or more types of di- or higher valent metal ions.

The metal ion includes a divalent metal ion, a trivalent metal ion, and a tetravalent metal ion.

Specific examples of the divalent metal ion include, but are not limited to, magnesium ion, calcium ion, and strontium ion. Of these, strontium ion is preferable.

Specific examples of the trivalent metal ion include, but are not limited to, aluminum ion, gallium ion, indium ion, and thallium ion. Of these, aluminum ion is it 0 preferable.

The two or more types of metal ions preferably have different valency to achieve different reaction speeds.

The diameter difference between metal ions is preferably 50 pm or greater, more preferably 55 to 120 pm, and furthermore preferably from 60 to 65 pm. A diameter difference of 50 pm or greater increases the reaction speed and strikes a balance between the hot offset property and low temperature ⁻fixa.bility.

As polyester resin cross-links, the distance between carboxyl groups (—COOH) allowed to react a metal ion becomes longer. A metal ion having a large ion radius present at the site between the carboxyl groups is likely to react, which promotes cross-linking. As the reaction product becomes large due to cross-linking, the steric effects become great, Small metal ions present at the site of steric effects can fill the gap between solids, which further advances cross-linking. Under promoted cross-linking, amorphous resin is allowed to react. If this reaction occurs to amorphous polyester resin, the hot offset property and fixability of the resin particle related to an embodiment is enhanced.

The type of metal ion in a non-linear polymer in the present disclosure can be qualitatively confirmed by analyzing the THF insoluble portion in a resin particle by fluorescent X-ray analysis. In the present disclosure, the metal ion can be subjected to quantitative analysis using a fluorescence X-ray analyzer (ZSX Primus IV, manufactured by Rigaku Corporation).

The form of a sample of the THF insoluble portion to be measured is not particularly limited. Pellet or sheet-shaped sample molded by a typical pressure molder is easy to handle. A pellet pill of the THF insoluble portion having a thickness of about 2 mm is obtained by placing a sample in a pill molding dice having a diameter of 15 mm and aging the dice in a thermostatic chamber at the glass transition temperature or higher than that for about an hour, immediately followed by applying a pressure of 6 MPa for one minute. The pellet pill obtained is placed in a sample holder of a fluorescence X-ray device and subjected to qualitative analysis, thereby detecting a metal element in the sample.

A liquid dispersion of fine particles can be aggregated by adding a flocculant or a typical method such as adjusting pH. Such a flocculant can be added as it is. However, an aqueous solution containing a flocculant is preferable to avoid a local high concentration. In addition, it is preferable to slowly add an aggregated salt while the particle diameter of a colored particle is monitored.

The temperature of a liquid dispersion during aggregation is preferably close to the Tg of a resin to be used. The aggregation speed becomes slow at excessively low temperatures, lowering the efficiency. Conversely, the aggregation speed becomes too fast at excessively high temperatures, resulting in increasing the production of coarse particles, which degrades the particle size distribution.

When the particle size reaches a target, it is suitable to stop further aggregation. Aggregation can be stopped by a method including: adding a low valence salt or chelate agent; adjusting pH; lowering the temperature of a liquid dispersion; or decreasing the concentration by adding much amount of an aqueous medium.

A liquid dispersion containing colored aggregated particles is obtained by the method described above.

It is possible to add wax as a releasing agent or a crystalline resin for enhancing the low temperature fixability in the aggregation process. In this case, liquid dispersion in which wax is dispersed in an aqueous medium is prepared or a liquid dispersion of crystalline resin is similarly prepared. The liquid dispersion prepared is then mixed with the liquid dispersion of colored fine particles mentioned above to obtain aggregated particles in which wax or crystalline resin is uniformly dispersed.

Fusion

The aggregated particles obtained are fused by heating to reduce the roughness of the particles, thus obtaining spheroidized particles. Liquid dispersion of aggregated particles are fused by heating during stirring. The liquid temperature is preferably around the Tg of a resin used.

Rinsing and Drying

The liquid dispersion of resin particles obtained by the method described above contains auxiliary materials such as aggregated salts other than the resin particles. The liquid dispersion is rinsed to extract the resin particles alone.

A method such as centrifugation, filtering under reduced pressure, and filter pressing are employed to rinse the resin particle. The method is not particularly limited in the present disclosure. A cake of resin is obtained by any of the methods. If one operation of rinsing does not suffice, the cake obtained is repeatedly dispersed in an aqueous medium to produce a slurry and extract resin particles from the slurry by one of the methods. Alternatively, auxiliary materials held in colored resin particles can be rinsed by infiltrating an aqueous medium through a cake if filtrating under reduced pressure or filter pressing is employed.

The aqueous medium for use in rinsing is water or a solvent mixture of water with alcohol such as methanol and ethanol. To reduce the burden on the environment, water is preferable.

Since the resin particles rinsed hold much amount of water inside, the resin particles alone can be obtained by removing the aqueous medium by drying. In the drying method, it is possible to use a drier such as a spray drier, vacuum freeze drier, vacuum drier, ventilation rack drier, mobile rack drier, fluid bed drier, rotary drier, and stirring drier. The resin particle dried is preferably further dried until the moisture in the particle is less than 1 percent. The colored resin particles after drying softly agglomerate. If this softly-aggregating particle is not convenient, it is suitable to pulverize the particle with a device such as a jet mill, Henschel mixer, super mixer, coffee mill, Oster blender, and food processor to loosen the softly agglomerated particle.

Annealing

When a crystalline resin is added in the aggregation process and the aggregated resin is subjected to annealing after drying, the amorphous resin and crystalline resin are phase-separated, which enhances the fixability. Specifically, the resin annealed is stored at around the Tg for 10 or more hours.

External Addition Treatment

Additives such as inorganic fine particles, line polymer particles, a fluidizer, and a cleaning improver can be added to or mixed with the resin particle obtained in the present disclosure to impart the flowability, chargeability, and cleaning property.

Specific examples of such mixing methods include, but are not limited to, a method in which an impact is applied to a mixture with a blade rotating at a high speed and a method in which a mixture is put into a jet air to collide particles against each other or complex particles to a suitable collision plate.

Specific examples of such mechanical impact applicators include, but are not limited to, ONG (manufactured by HOSOKAWA MICRON CO., LID.), modified I TYPE MILL (manufactured by Nippon Pneumatic Mfg. Co., Ltd.) in which the air pressure of pulverization is reduced, HYBRIDIZATION SYSTEM (manufactured by NARA MACHINE CO., LTD,), KRYPTRON SYSTEM (manufactured by KAWASAKI HEAVY IUDUSTRIES, LTD.), and automatic mortars.

External Additive

The inorganic fine particle preferably has a primary particle diameter of from 5 nm to 2 μm, and more preferably from 5 nm to 500 nm. In addition, the specific surface area of such inorganic particulates measured by the BET method is preferably from 20 to 500 rn:²/g. The proportion of this inorganic fine particle to a toner is preferably from 0.01 to 5 percent by mass.

Specific examples of such inorganic fine particles include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, mamesium oxide, zirconium oxide, barium sulfate, barium carbonate, calcium carbonate, silicon carbide, and sil icon nitride.

The fine polymer particles include, but are not limited to, polystyrene, methacrylates, and acrylates obtained by soap-free emulsion polymerization, suspension polymerization, or dispersion polymerization, and polycondensed particles such as silicone, benzoguanamine, and nylon, and polymer particles of thermocuring resin.

The external additive such as a fluidizer can be hydrophobized by surface treatment to enhance the hydrophobicity and prevent the deterioration of the fluidity and chargeability in a high humidity environment.

Specific examples of surface treating agents include, but are not limited to, silane coupling agents, silyl agents, silane coupling agents having a fluorine alkyl group, organic titanate coupling agents, aluminum-based coupling agents, silicone oil, and modified-silicone oil.

Cleaning improvers remove a development agent remaining on an image bearer such as a photoconductor and a primary transfer body.

Specific examples include, but are not limited to, zinc stearate, calcium stearate and metal salts of fatty acid acids such as stearic acid and polymer fine particles such as polymethyl methacrylate fine particles and polystyrene fine particles, which are prepared by a method such as soap-free emulsion polymerization. Such polymer fine particles preferably have a relatively- sharp particle size distribution and a volume average particle size of from 0.01 to 1 μm.

Measuring Method

Method of Measuring Carbon-14 Concentration

The carbon-14 concentration of resin particles is measured by radiocarbon dating. Resin particles are burnt to reduce carbondioxide (CO2) in the particles, thereby obtaining graphite (C). Carbon-14 concentration of graphite is measured by an Accelerator Mass Spectroscopy (AMS), manufactured by Beta Analytic.

Diameter of Toner Particle

The diameter of resin particle is measured with Coulter Multisizer Ill (manufactured by Beckman Coulter, Inc.). The diameter of toner particle is measured in the following manner.

A total of 2 mL of a surfactant, dodecyl benzene sulphonic acid sodium, manufactured by Tokyo Chemical industry Co. Ltd., is added as a dispersant to 100 mL of an electrolyte. The electrolyte is NaCl aqueous solution at approximately 1 percent prepared by using primary sodium chloride. One of such an electrolyte is ISOTON-II (manufactured by Beckman Coulter, Inc.). A total of 10 mg of a solid measuring sample is added to the liquid mixture containing the electrolyte and the surfactant to obtain an electrolyte in which the sample is suspended. The electrolyte containing the sample suspension is subjected to dispersion with an ultrasonic wave dispersing device for about one to about three minutes. The volume and the number of resin particles are measured with Coulter Multisizer III with an aperture of 100 μm to calculate the volume distribution and the number distribution. The volume average particle diameter (Dv) of the resin particles is calculated from the distributions obtained.

Method of Measuring Melting Point and Glass Transition Temperature (Tg)

The melting point and the glass transition temperature (Tg) can be measured by a device such as differential scanning calorimetry (DSC) system, Q-200, manufactured by TA Instruments, in the present disclosure.

The melting point and the glass transition temperature of a target sample are measured in the following manner.

About 5.0 mg of a target sample is placed in an aluminum sample container, which is placed on a holder unit. The unit and the container are placed in an electric furnace. Then the unit and container are heated in a nitrogen atmosphere from −80 degrees C. to 150 degrees C. at a temperature rising speed of 10 degrees C/min (first temperature rising). Thereafter, the system is cooled down from 150 degrees C. to −80 degrees C. at a temperature falling speed of −10 degrees C/min and heated again to 150 degrees C. at a temperature rising speed of 10 degrees Clmin (second temperature rising). In each of the first temperature rising and second temperature rising. DSC curve is measured by Q-200, manufactured by TA Instruments.

Based on the DSC curve at the first temperature rising selected from the obtained DSC curves using the analysis program installed in the Q-200 system, the glass transition temperature at the first temperature rising of the target sample is obtained. The DSC curve at the second temperature rising is selected in the same manner as that at the first temperature rising and the glass transition temperature of the target sample is obtained,

Based on the DSC curve at the first temperature rising is selected from the obtained DSC curves using the analysis program installed in the Q-200 system, the endothermic peak temperature at the first temperature rising of the target sample is obtained as the melting point. The DSC curve at the second temperature rising is selected in the same manner as that at the first temperature rising and the endothermic peak temperature of the target sample is obtained as the melting point.

In the present specification, the glass transition temperature of a resin particle as the target sample at the first temperature rising is referred to as Tgtst and that at the second temperature rising referred to as Tg2nd.

In the present specification, the glass transition temperature and the melting point of each of the polyester resin A, the amorphous polyester resin B, the crystalline polyester resin C, and the other components such as the releasing agent mentioned above are respectively the Tg and the endothermic peak temperature at the second temperature rising, unless otherwise specified.

Average Particle Diameter and Average Circularity

In this embodiment, the average particle diameter and average circularity are measure by using a flow-type particle image analyzer, FPIA-3000, manufactured by Sysmex Corporation.

The specific procedure for obtaining the average circularity is as follows: (1) A surfactant serving as a dispersion agent, preferably 0.1 to 5 ml of an alkylbenzenesulfonic acid salt, is added to 100 to 150 ml of water from which solid impurities have been preliminarily removed; (2) about 0.1 to about 0.5 g of a sample to be measured is added to the mixture prepared in (1); (3) the liquid suspension in which the sample is dispersed by an ultrasonic dispersion device for about 1 to about 3 minutes to achieve a concentration of the particles of from 3,000 to 10,000 particles per microlitler; and (4) the average particle diameter, the average circularity, and the standard deviation (SD) of the circularity are measured by the device mentioned above.

The particle diameter is defined as the equivalent circle diameter. The average particle diameter is obtained from the equivalent circle diameter based on number. The analysis conditions of the flow bed particle image analyzer are as follows. Particle diameter: 0.5 μm ≤equivalent circle diameter based on number≤200.0 μm Particle shape: 0.93≤circularity≤1.00

The definition of the average circularity in the present embodiment is as follows. Average circularity=(perimeter of circle having same area as that of projected image of particle)/(perimeter of projected image of particle)

Measuring of Molecular Weight

One way of measuring the molecular weight of each component of a resin particle is as follows.
Gel permeation chromatography(GPC)measuring device: GPC-8220 GPC, manufactured by TOSOH CORPORATION
Column: TSK gel Super HZM-M, 15 cm triplet, manufactured by TOSOH CORPORATION
Temperature: 40 degrees C.
Solvent: THF
Flow rate: 0.35 mL/min
Sample: 100 μl of 0.15 percent sample by mass

Pretreatment of sample: resin particles are dissolved in tetrahydrofuran (THF) containing a stabilizer, manufactured by Wako Pure Chemical Industries, Ltd., at 0.15 percent by mass, followed by filtering with 0.2 μm. The filtrate is used as a sample. A total of 100 μL, of the THF sample solution is placed in the measuring device.

For the molecular weight measuring, the molecular weight distribution of the sample is calculated by the relationship between the number of counts and the logarithm values of the calibration curve created from several types of the monodispersed polystyrene reference samples. As the reference polystyrene sample for the calibration curve, Showdex STANDARD Std. No. S-7300, S-210, S-390, S-875, S-1980, S-10.9, 5-629, 5-3,0, and S-0.580, all manufactured by Showa Denko K:K., are used. A refractive index (RI) detector is used as a detector.

Presence of Metal Element in THF Insoluble Portion

The presence of the metal element constituting metal ions in a non-linear polymer in the present disclosure can be qualitatively confirmed by analyzing the THF insoluble portion in a resin particle by fluorescent X-ray analysis.

In the present disclosure, the metal element is subjected to quantitative analysis using a fluorescence X-ray analyzer (ZSX Primus IV, manufactured by Rigaku Corporation).

The form of a sample of the THF insoluble portion to be measured is not particularly limited. Pellet or sheet-shaped sample molded by a typical pressure molder is easy to handle. A pellet pill of THF insoluble portion having a thickness of about 2 mm is obtained by placing a sample in a pill molding dice having a diameter of 15 nun and aging the dice in a 1_{—} 0 thermostatic chamber at the glass transition temperature or higher than that for about an hour, immediately followed by applying a pressure of 6 MPa for one minute. The pellet pill obtained is placed in a sample holder of a fluorescence X-ray device and subjected to qualitative analysis, thereby detecting a metal element in the sample.

Toner Accommodating Unit

The toner accommodating unit in the present disclosure contains toner in a unit capable of accommodating the toner. The toner accommodating unit includes a toner accommodating container, a developing device, and a process cartridge,

The toner accommodating container is a vessel containing toner.

The developing device accommodates toner and develops an image with the toner.

The process cartridge integrally includes at least an image bearer and a developing device, accommodates toner, and is detachably attachable to an image forming apparatus. The process cartridge may further include at least one member selected from the group consisting of a charger, an exposure, and a cleaning device.

Images are formed with the toner of the present disclosure accommodated in the toner accommodating unit of the present disclosure mounted in an image forming apparatus. The images formed with the toner has an excellent strength and low temperature fixability.

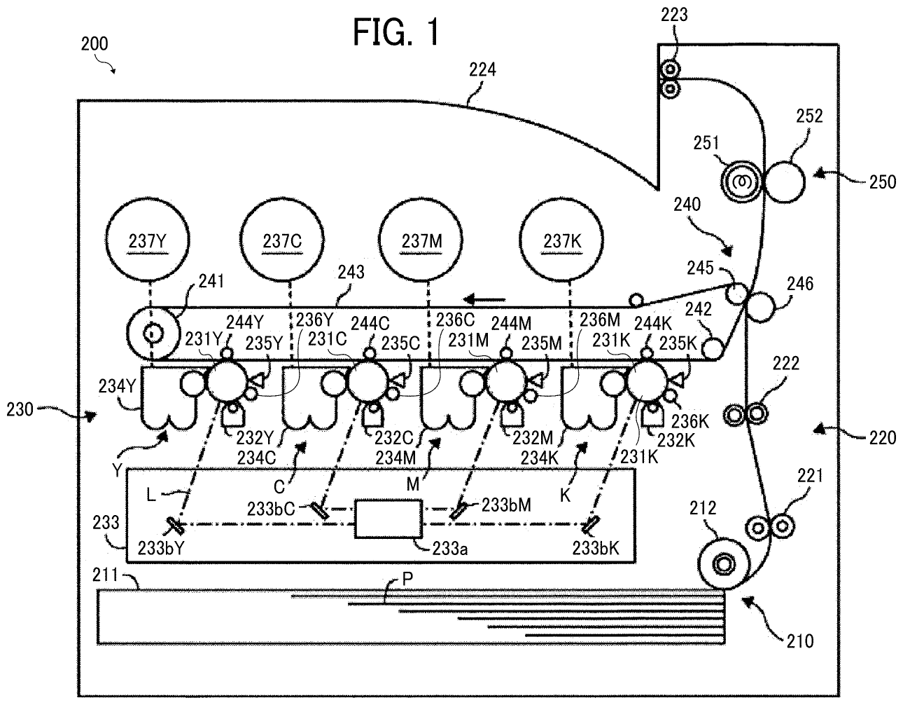

Next, an embodiment of forming images with the toner of the present disclosure using an image forming apparatus is described with reference to FIG. 1. One of the image forming apparatus in the present embodiment is a printer. However, the image forming apparatus is not particularly limited to an apparatus such as a. printer, a photocopier, a facsimile machine, or a multifunction peripheral as long as it can form images with toner.

As illustrated in FIG. 1, an image forming apparatus 200 includes a sheet feeding unit 210, a conveyance unit 220, an image forming unit 230, a transfer unit 240, and a fixing unit 250.

The sheet feeding unit 210 includes a sheet feeding cassette 211 on which sheets to be fed are piled and a feeding roller 212 that feeds a sheet P piled on the feeding cassette 211 one by one as illustrated in FIG. 1.

The conveyance unit 220 includes a roller 221 for conveying the sheet P fed by the feeding roller 212 toward the transfer unit 240, a pair of timing rollers 222 for pinching the front end of the sheet P conveyed by the roller 221 at a standby position and sending out the sheet P to the transfer unit 240 at a particular timing, and ejection rollers 223 for ejecting the sheet P on which toner is fixed by the fixing unit 250 to an ejection tray 224.

The image forming unit 230 includes an image forming unit Y that forms an image using a developing agent containing a toner Y of yellow, an image forming unit C that forms an image using a developing agent containing a toner C of cyan, an image forming unit M that forms an image using a. developing agent containing a toner M of magenta., and an image forming unit K that forms an image using a developing agent containing a toner K of black, which are regularly separated from each other from the left to the right in this order as illustrated in FIG. 1. The image forming unit 230 also includes an irradiator 233. Each of the toner Y, C, M and K is manufactured by the manufacturing method described above.

The four image forming units illustrated in FIG. 1 have the substantially same structure except for the developing agents used for each image forming unit. Each of image forming units is disposed clockwise rotatable as illustrated in FIG. 1 and includes a drum photocondcutor (231Y, 2310, 2311, and 231K) that bears a latent electrostatic image and a. toner image, a charger (232Y, 232C, 232M, and 232K) that uniformly charges the surface of the drum photocondcutor (231Y, 2310. 231M, and 231K), a toner cartridge (237Y, 2370, 237M, and 237K) that supplies the color toner (Y, C, M, and K), a. developing device (234Y, 234C, 2341. and 234K) that renders the latent electrostatic image formed on the surface of the drum photocondcutor (231Y, 2310, 231M, and 231K) visible with the toner supplied from the toner cartridge (237Y, 237C, 237M, and 237K) to form a toner image, a quencher (235Y, 235C, 235M, and 235K) that neutralizes the surface of the drum photocondcutor (231Y 2310, 2311, and 231K) after the toner image is primarily transferred to a transfer medium, and a cleaner (236Y, 236C, 236M, and 236K) that clears the surface of the drum photocondcutor (231Y 231C, 231M, and 231K) of the toner remaining thereon after the quencher (235Y, 235C, 2351, and 235K) neutralizes the drum photocondcutor (231Y, 231C, 231M, and 231K).

The irradiator 233 is to irradiate the drum photoconductor (231Y, 2310, 231M, and 231K) with a laser beam L that is emitted from a light source 233a in response to image data and reflected by a polygon mirror (233bY, 233bC, 233bM, and 233bK) rotatable driven by a motor. A latent electrostatic image is thus formed on the drum photoconductor 231 according to the image data.

The transfer unit 240 includes a driving roller 241, a driven roller 242, an intermediate transfer belt 243 as a transfer medium that is stretched between the rollers and disposed rotatable counterclockwise in FIG, 1 in accordance with the drive of the driving roller 241, a primary transfer roller (2441 2440, 244M, and 244K) disposed facing the drum photoconductor 231 with the intermediate transfer belt 243 therebetween, and a secondary transfer roller 246 disposed at the point of the toner image transferred to the sheet P while facing a secondary facing roller 245 with the intermediate transfer belt 243 therebetween.

The transfer unit 240 applies a primary transfer bias to the primary transfer roller 244 to primarily transfer each toner image formed on the surface of the drum photoconductor 231 onto the intermediate transfer belt 243. The transfer unit 240 also applies a secondary transfer bias to the secondary transfer roller 246 to secondarily transfer the toner image on the intermediate transfer belt 243 to the sheet P. which is nipped between the secondary transfer roller 246 and the secondary facing roller 245.

The fixing unit 250 includes a heater inside, a heating roller 251, which heats the sheet P to temperatures higher than the lowest fixing temperature of the toner, and a rotatable pressing roller 252, which forms the contact surface as the nipping portion together with the 0 heating roller 251 by pressing the heating roller 251. Heat and pressure are applied to the color toner image on the sheet P at the nipping portion, thereby fixing the color toner image. The sheet P on which the color toner image is fixed is ejected to the ejection tray 224 by the ejection rollers 223, which completes a series of image forming process.

Process Cartridge

The process cartridge relating to the present disclosure is made to be detachably attachable to an image forming apparatus. It includes at least a latent electrostatic image bearer and a developing device that renders the latent electrostatic image visible with a developing agent containing the toner of the present disclosure to form a toner image. The process cartridge of the present disclosure furthermore includes other optional devices.

The developing device includes at least a developing agent container that contains a developing agent and a developing agent bearer that bears and conveys the developing agent in the developing agent container. The developing device may furthermore optionally include a regulating member for regulating the thickness of the developing agent borne on the bearer.

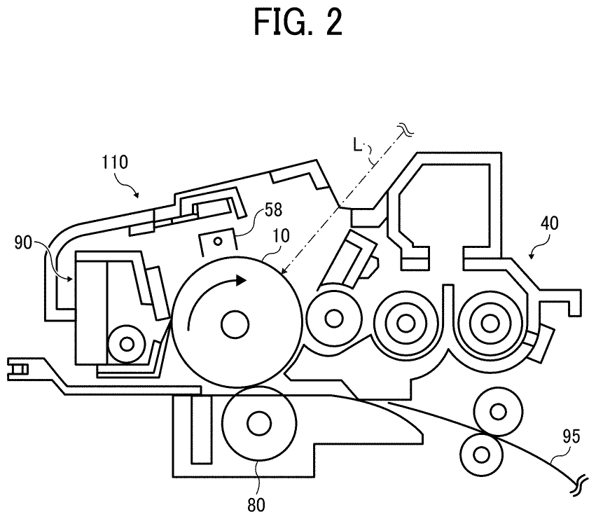

FIG. 2 is a diagram illustrating an example of the process cartridge relating to the present disclosure. The process cartridge 110 includes a drum photoconductor 10, a corona. charger 58, a developing device 40, a transfer roller 80, and a cleaner 90 and prints an image on a transfer sheet 95. L represents irradiation light such as laser beams. The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, embodiments of the present disclosure are described in detail with reference to Examples but are not limited thereto. “Parts” represents percent by mass unless otherwise specified. “Percent” represents percent by mass unless otherwise specified.

Manufacturing Example of Prepolymer A

Synthesis of Prepolymer A-1

3-methyl-1,5-pentane diol, isophthalic acid, and adipic acid were charged in a reaction container equipped with a heater, a cooling device, a stirrer, and a nitrogen introducing tube together with titanium tetraisopropoxide in a proportion of 1,000 ppm to the resin component. The molar ratio of hydroxyl group to carboxyl group, OH to COOH, was 1.1:1, 3-methyl-1,5-pentane diol in the entire diol component was 110 mol percent, and isophthalic acid and adipic acid respectively accounted for 40 mol percent and 60 mol percent in the entire dicarboxylic acid component. Thereafter, the system was heated to 200 degrees C. in about four hours and then heated to 230 degrees C. in two hours to allow reaction until water did not discharge. Thereafter, the resulting reaction product was allowed to react for five hours under a reduced pressure of from 10 to 15 mm Hg to obtain intermediate polyester A-1.

Intermediate polyester A-1 and hexamethylene isocyanate derivative (1-IDI isocyanulate) were placed in a reaction chamber equipped with a heater, a cooling device, a. stirrer, and a nitrogen introducing tube at a molar ratio of isocyanulate group in HIM isocyanulate to hydroxyl group in intermediate polyester A-1, i.e., NCO/OH, of 2.0:1. Ethyl acetate was added to dissolve the substance in the chamber to obtain 50 percent ethyl acetate solution. Thereafter, the solution was heated to 80 degrees C. to allow reaction for five hours in a nitrogen atmosphere to obtain an ethyl acetate solution of OH group terminated prepolymer A-1, which was a prepolytner having a hydroxyl group at its terminal. Thereafter, the system was decompressed until the amount of ethyl acetate remaining in the ethyl acetate solution of OH group terminated prepolymer A-1 was 100 ppm or less.

Next, OH group terminated prepolymer A-1 and monomethyl ester succinic acid were placed in a reaction chamber equipped with a heater, a cooling device, a stirrer, and a nitrogen introducing tube at a molar ratio of methyl group in monomethyl to hydroxyl group in OH group terminated prepolymer A-1, i.e., CH₃/OH, of 2.0:1 and allowed to react at 150 degrees C. for six hours. As a result, prepolymer A-i, a carboxylic acid-terminated non-linear prepolymer, was obtained.

Synthesis of Prepolymer A-2

3-methyl-1,5-pentane diol, isophthalic acid, adipic acid, and trimellitic anhydride were charged in a reaction container equipped with a heater, a cooling device, a stirrer, and a nitrogen introducing tube together with titanium tetraisopropoxide in a proportion of 1,000 ppm to the resin component. The malar ratio of hydroxyl group to carboxyl group, OH to COOH, was 1.1:1, 3-methyl-1,5-pentane diol in the entire diol component was 110 mol percent. Isophthalic acid and adipic acid respectively accounted for 40 mol percent and 60 mol percent in the entire dicarboxylic acid component. The proportion of trimellitic anhydride to the entire monomers was 1 mol percent. Thereafter, the system was heated to 200 degrees C. in about four hours and then heated to 230 degrees C. in two hours to allow reaction until water did not discharge, Thereafter, the resulting reaction product was allowed to react for five hours under reduced pressure of from 10 to 15 mm Hg to obtain intermediate polyester A-2.

Intermediate polyester A-2 and hexamethylene isocyanate derivative (HDI isocyanulate) were placed in a reaction chamber equipped with a heater, a cooling device, a. stirrer, and a nitrogen introducing tube at a molar ratio of isocyanulate group in 1-HDI isocyanulate to hydroxyl group in intermediate polyester A-2, i.e., NCO/011, of 2,0:1. Ethyl acetate was added to dissolve the substance in the chamber to obtain 50 percent ethyl acetate solution. Thereafter, the solution was heated to 80 degrees C. to allow reaction for five hours in a nitrogen atmosphere to obtain an ethyl acetate solution of OH group terminated prepolymer A-2, which was a prepolymer having a hydroxyl group at its terminal.

Thereafter, the system was decompressed until the amount of ethyl acetate remaining in the ethyl acetate solution of OH group terminated prepolymer A-2 was 100 ppm or less.

Next, OH group terniinated prepolymer A-2 and monomethyl ester succinic acid were placed in a reaction chamber equipped with a heater, a cooling device, a stirrer, and a nitrogen introducing tube at a molar ratio of methyl group in monomethyl to hydroxyl group in OH group terminated prepolymer A-2, i.e., CH₃/OH, of 2.0:1 and allowed to react at 150 degrees C. for six hours. As a result, prepolymer A-2, a carboxylic acid-terminated non-linear prepolymer was obtained.

Synthesis of Prepolymer A-3

3-methyl-1,5-pentane diol and adipic acid were charged in a reaction container equipped with a heater, a cooling device, a stirrer, and a nitrogen introducing tube together with titanium tetraisopropoxide in a proportion of 1,000 ppm to the resin component. The molar ratio of hydroxyl group to carboxyl group, OH to COOH, was 1.1:1, 3-methyl-1,5-pentane diol in the entire diol component was 110 mol percent, and adipic acid accounted for 100 mol percent in the entire dicarboxylic acid component. Thereafter, the system was heated to 200 degrees C. in about four hours and then heated to 230 degrees C in two hours to allow reaction until water did not discharge. Thereafter, the resulting reaction product was allowed to react for five hours under reduced pressure of from 10 to 15 mm Hg to obtain intermediate polyester A-3.

Intermediate polyester A-1 and hexamethylene isocyanate derivative MIX isocyanulate) were placed in a reaction chamber equipped with a heater, a cooling device, a. stirrer, and a nitrogen introducing tube at a molar ratio of isocyanulate group in HDI isocyanulate to hydroxyl group in intermediate polyester A-1, i.e., NCO/OH, of 2,0:1, Ethyl acetate was added to dissolve the substance in the chamber to obtain 50 percent ethyl acetate solution. Thereafter, the solution was heated to 80 degrees C. to allow reaction for five hours in a nitrogen atmosphere to obtain an ethyl acetate solution of OH group terminated prepolymer A-3, which was a prepolymer having a hydroxyl group at its terminal. Thereafter, the system was decompressed until the amount of ethyl acetate remaining in the ethyl acetate solution of OH group terminated prepolymer A-3 was 100 ppm or less.

Next, OH group terminated prepolymer A-3 and monomethyl ester succinic acid were placed in a reaction chamber equipped with a heater, a cooling device, a stirrer, and a nitrogen introducing tube at a molar ratio of methyl group in monomethyl to hydroxyl group in OFT group terminated prepolymer A-3, i.e., CH₃/OH, of 2.0:1 and allowed to react at 150 degrees C. for six hours. As a result, prepolymer A-3, a carboycarboxylic acid-terminated non-linear prepolymer, was obtained.

Synthesis of Prepolymer A-4

3-methyl-1,5-pentane diol and isophthalic acid were charged in a. reaction container equipped with a heater, a cooling device, a stirrer, and a nitrogen introducing tube together with titanium tetraisopropoxide in a proportion of 1,000 ppm to the resin component. The molar ratio of hydroxyl group to carboxyl group, OH to COOH, was 1.1:1, 3-methyl-1,5-pentane diol in the entire diol component was 110 mol percent, and isophthalic acid accounted for 100 mol percent in the entire dicarboxylic acid component. Thereafter, the system was heated to 200 degrees C. in about four hours and then heated to 230 degrees C. in two hours to allow reaction until water did not discharge. Thereafter, the resulting reaction product was allowed to react for live hours under reduced pressure of from 10 to 15 mm Hg to obtain intermediate polyester A-4.

Intermediate polyester A-4 and hexamethylene isocyanate derivative (HDI isocyanulate) were placed in a reaction chamber equipped with a heater, a cooling device, a stirrer, and a nitrogen introducing tube at a molar ratio of isocyanulate group in HDI isocyanulate to hydroxyl group in intermediate polyester A-4, i.e., NCO/OH, of 2,0:1. Ethyl acetate was added to dissolve the substance in the chamber to obtain 50 percent ethyl acetate solution. Thereafter, the solution was heated to 80 degrees C. to allow reaction for five hours in a nitrogen atmosphere to obtain an ethyl acetate solution of OH group terminated. prepolymer A-4, which was a prepolymer having a hydroxyl group at its terminal. Thereafter, the system was decompressed until the amount of ethyl acetate remaining in the ethyl acetate solution of OH group terminated prepolymer A-4 was 100 ppm or less,

Next, OH group terminated prepolymer A-4 and monomethyl ester succinic acid 5 were placed in a reaction chamber equipped with a heater, a cooling device, a stirrer, and a nitrogen introducing tube at a molar ratio of methyl group in monomethyl to hydroxyl group in OH group terminated prepolymer A-4, i.e., CHs/OH, of 2.0:1 and allowed to react at 150 degrees C. for six hours. As a result, prepolymer A-4, a carboxylic acid-terminated non-linear prepolymer, was obtained.

Manufacturing Example of Prepolymer

Synthesis of Prepolymer a-1

3-methyl-1,5-pentane diol, isophthalic acid, adipic acid, and trimellitic anhydride were charged in a reaction container equipped with a heater, a cooling device, a stirrer, and a nitrogen introducing tube together with titanium tetraisopropoxide in a proportion of 1,000 ppm to the resin component. The molar ratio of hydroxyl group to carboxyl group, OH to COOK, was 1.1:1, 3-methyl-1,5-pentane diol in the entire diol component was 110 mol percent. isophthalic acid and adipic acid respectively accounted for 40 mol percent and 60 mol percent in the entire dicarboxylic acid component. The proportion of trimellitic anhydride to the entire monomers was 1 mol percent. Thereafter, the system was heated to 200 degrees C. in about four hours and then heated to 230 degrees C. in two hours to allow reaction until water did not discharge. Thereafter, the resulting reaction product was allowed to react for five hours under a reduced pressure of from 10 to 15 111M Hg to obtain intermediate polyester a-1.

Intermediate polyester a-1 and isophorone isocyanate (IPD1) were charged in a reaction container equipped with a heater, a cooling device, a stirrer, and a nitrogen introducing tube at a molar ratio of isocyanulate group in IPDT and hydroxyl group in intermediate polyester a-1, i.e., NCO/OH, of 2.0:1. Ethyl acetate was added to dissolve and dilute the substance in the chamber followed by allowing to react at 100 degrees C. for five hours, thereby obtaining a 50 percent ethyl acetate solution. Resultantly, prepolymer a-1, non-linear prepolymer, wa.s obtained.

Synthesis of Prepolymer a-2

3-methyl-1,5-pentane diol, isophthalic acid, and adipic acid were charged in a reaction container equipped with a heater, a cooling device, a stirrer, and a nitrogen introducing tube together with titanium tetraisopropoxide in a proportion of 1,000 ppm to the resin component. The molar ratio of hydroxyl group to carboxyl group, COOH to OH, was 1.1, 3-methyl-I,5-pentane diol in the entire diol component was 100 mol percent, and isophthalic acid and adipic acid respectively accounted for 50 mol percent and 60 mol percent in the entire dicarboxylic acid component. Thereafter, the system was heated to 200 degrees 5 C in about four hours and then heated to 230 degrees C. in two hours to allow reaction until water did not discharge. Thereafter, the reaction product wa.s allowed to react for five hours under a reduced pressure of from 10 to 15 mmHg to obtain prepolymer

Synthesis of Prepolymer a-3

3-methyl-1,5-pentane diol and 1,10-dodecanedioic acid were charged in a reaction container equipped with a heater, a cooling device, a stirrer, and a. nitrogen introducing tube together with titanium tetraisopropoxide in a proportion of 1,000 ppm to the resin component. The molar ratio of hydroxyl group to carboxyl group, OH to COOK was 1.1, 3-methyl-1,5-pentane diol in the entire diol component was 110 mol percent, and 1,10-decane dicarboxylic acid accounted for 100 mol percent in the entire dicarboxylic acid component. Thereafter, the system was heated to 200 degrees C. in about four hours and then heated to 230 degrees C. in two hours to allow reaction until water did not discharge. Thereafter, the resulting reaction product was allowed to react for five hours under reduced pressure of from 10 to 15 mm Hg to obtain intermediate polyester a-3.

Intermediate polyester a-3 and hexamethylene isocyanate derivative (HDI isocyanulate) were placed in a reaction chamber equipped with a heater, a cooling device, a stirrer, and a nitrogen introducing tube at a molar ratio of isocyanulate group in HDI isocyanulate to hydroxyl group in intermediate polyester a-3, i.e., NCO/OH, of 2.0:1. Ethyl acetate was added to dissolve the substance in the chamber to obtain 50 percent ethyl acetate solution. Thereafter, the solution was heated to 80 degrees C. to allow reaction for five hours in a nitrogen atmosphere to obtain an ethyl acetate solution of OH group terminated prepolymer a-3, which was a prepolymer having a hydroxyl group at its terminal. Thereafter, the system was decompressed until the amount of ethyl acetate remaining in the ethyl acetate solution of OH group terminated prepolymer a-3 was 100 ppm or less.

Next, OH group terminated prepolymer a-3 and monomethyl ester succinic acid were placed in a reaction chamber equipped with a heater, a cooling device, a stirrer, and a nitrogen introducing tube at a molar ratio of methyl group in rnonomethyl to hydroxyl group in OH group terminated prepolymer a-3, i.e., CH₃/OH, of 2.0 and allowed to react at 150 degrees C. for six hours. As a result, prepolymer a-3, a carboxylic acid-terminated non-linear prepolymer was obtained.

Manufacturing of Amorphous Polyester Resin B

Synthesis of Amorphous Polyester Resin B-1

Plant-derived propylene glycol, terephthalic acid, and plant-derived succinic acid were placed in a four-necked flask equipped with a nitrogen introducing tube, a dehydration tube, a stirrer, and a thermocouple at a molar ratio of terephthalic acid to succinic acid of 86:14 and a molar ratio of hydroxyl group to carboxyl group, OH to COOH, of 1.3:1 followed by allowing to react together with titanium tetraisopropoxide (500 ppm to the resin portion) at 230 degrees C. under normal pressure for eight hours and further react under a reduced pressure of from 10 to 15 mmHg for four hours. Then trimellitic anhydride was placed in the reaction container to achieve a proportion of 1 mol percent to the entire resin component followed by allowing to react at 180 degrees C. under normal pressure for three hours, thereby obtaining amorphous polyester resin B-1.

Synthesis of Amorphous Polyester Resin B-2

Propylene glycol, an adduct of bisphenol A with 2 mols of propylene oxide, terephthalic acid, and plant-derived succinic acid were placed in a four-necked flask equipped with a nitrogen introducing tube, a dehydration tube, a stirrer, and a thermocouple at a molar ratio of propylene glycol to the adduct of bisphenol A with 2 mots of propylene oxide of 60:40, a molar ratio of terephthalic acid to succinic acid of 86:14, and a molar ratio of hydroxyl group to carboxyl group, OH to COOH, of 1.3:1 followed by allowing to react together with titanium tetraisopropoxide (500 ppm to the resin portion) at 230 degrees C. under normal pressure for eight hours and further react under a reduced pressure of from 10 to 15 mmHg for four hours. Then trimellitic anhydride was placed in the reaction container to achieve a proportion of 1 mol percent to the entire resin component followed by allowing to react at 180 degrees C. under normal pressure for three hours, thereby obtaining amorphous polyester resin B-2.

Synthesis of Amorphous Polyester Resin B-3

An adduct of bisphenol A with 2 mols of ethylene oxide, an adduct of bisphenol A with 2 mols of propylene oxide, terephthalic acid, and adipic acid were placed in a four-necked flask equipped with a nitrogen introducing tube, a. dehydration tube, a stirrer, and a thermocouple at a molar ratio of the adduct of bisphenol A with 2 mols of ethylene oxide to the adduct of bisphenol A with 2 mols of propylene oxide of 60:40, a molar ratio of terephthalic acid to adipic acid of 97:3, and a molar ratio of hydroxyl group to carboxyl group, OH to COOH, of 1.3:1 followed by allowing to react together with titanium tetraisopropoxide (500 ppm to the resin portion) at 230 degrees C. under normal pressure for eight hours and further react under a reduced pressure of from 10 to 15 mmHg for four hours. Then trimellitic anhydride was placed in the reaction container to achieve a proportion of 1. mol percent to the entire resin component followed by allowing to react at 180 degrees C. 5 under normal pressure for three hours, thereby obtaining amorphous polyester resin B-3.

Synthesis of Amorphous Polyester Resin B-4

An adduct of bisphenol A with 2 rn.ols of ethylene oxide, an adduct of bisphenol A with 2 mols of propylene oxide, terephthalic acid, and plant-derived succinic acid were placed in a four-necked flask equipped with a nitrogen introducing tube, a dehydration tube, a stirrer, and. a thermocouple at a molar ratio of the adduct of bisphenol A with 2 mots of ethylene oxide to the adduct of bisphenol A with 2 mols of propylene oxide of 60:40, a molar ratio of terephthalic acid to succinic acid of 86:14, and a molar ratio of hydroxyl group to carboxyl group, OH to COOH, of 1.3:1 followed. by allowing to react together with titanium tetraisopropoxide (500 ppm to the resin portion) at 230 degrees C. under normal pressure for eight hours and further react under a reduced pressure of from 10 to 15 mrnFlg for four hours. Then trimellitic anhydride was placed in the reaction container to achieve a proportion of 1 mol percent to the entire resin component followed by allowing to react at 180 degrees C. under normal pressure for three hours, thereby obtaining amorphous polyester resin B-4.

Manufacturing of Crystalline Polyester Resin C

Synthesis of Crystalline Polyester Resin C-1

Plant-derived sebacic acid and 1,6-hexane diol were placed in a 5L four-necked flask equipped with a nitrogen introducing tube, a dehydration tube, a stirrer, and a thermocouple at molar ratio of hydroxyl group to carboxyl group, OH/COOH, of 0.9:1 followed by allowing to react together with titanium tetraisopropoxide (500 ppm to the resin portion) at 180 degrees C. under normal pressure for ten hours. The system was then heated to 200 degrees C. and allowed to react for three hours followed by allowing to react under a pressure of 8.3 kPa for two hours to obtain crystalline polyester resin C-I.

Synthesis of Crystalline Polyester Resin C-2

Crystalline polyester resin C-2 was obtained in the same manner as in Synthesis of Crystalline Polyester Resin C-1 except that diol was replaced with plant-derived ethylene glycol.

Synthesis of Crystalline Polyester Resin C-3

Crystalline polyester resin C-3 was obtained in the same manner as in Synthesis of Crystalline Polyester Resin C-i except that dicarboxylic acid was replaced with adipic acid.

Preparation of Liquid Dispersion of Crystalline Polyester Resin

Preparation of Liquid Dispersion 1 of Crystalline Polyester Resin

A total of 45 parts of the crystalline polyester resin C-1 and 450 parts of ethyl acetate were placed in a container equipped with a stirrer and a thermometer and heated to 80 degrees C. under stirring. After maintaining the temperature of 80 degrees C. for five hours, the system was cooled down to 30 degrees C. in an hour. The resulting mixture was subjected to dispersion by a bead mill (UUIRAVISCOMILL, manufactured by AINIEIX) under conditions of a liquid transfer speed of 1 kalhour, a disk peripheral speed of 6 m/s, and a filling ratio of 0.5 mm zirconia beads of 80 percent by volume with three passes to obtain liquid dispersion 1 of crystalline polyester resin. The volume average particle diameter of the crystalline polyester resin particles obtained was 350 nm and the solid portion concentration of the resin particle was 10 percent.

Preparation of Liquid Dispersion 2 of Crystalline Polyester Resin

A total of 45 parts of the crystalline polyester resin C-2 and 450 parts of ethyl acetate were placed in a container equipped with a stirrer and a thermometer and heated to 80 degrees C. under stirring. After maintaining the temperature of 80 degrees C. for live hours, the system was cooled down to 30 degrees C. in an hour. The resulting mixture was subjected to dispersion by a bead mill (ULTRAVISCOMILL, manufactured by AIMEX) under conditions of a liquid transfer speed of 1 kg/hour, a disk peripheral speed of 6 m/s, and a filling ratio of 0.5 mm zirconia beads of 80 percent by volume with three passes to obtain liquid dispersion 2 of crystalline polyester resin. The volume average particle diameter of the crystalline polyester resin particles obtained was 350 nm and the solid portion concentration of the resin particle was 10 percent.

Preparation of Liquid Dispersion 3 of Crystalline Polyester Resin

A total of 45 parts of the crystalline polyester resin C-3 and 450 parts of ethyl acetate were placed in a container equipped with a stirrer and a thermometer and heated to 80 degrees C. under stirring. After maintaining the temperature of 80 degrees C. for five hours, the system was cooled down to 30 degrees C. in an hour. The resulting mixture was subjected to dispersion by a bead mill (ULTRAVISCOMILL, manufactured by AMEX) under conditions of a liquid transfer speed of 1 kg/hour, a disk peripheral speed of 6 rills, and. a tilling ratio of 0.5 mm zirconia beads of 80 percent by volume with three passes to obtain liquid dispersion 3 of crystalline polyester resin. The volume average particle diameter of the crystalline polyester resin particles obtained was 360 nm and the solid portion concentration of the resin particle was 10 percent.

Manufacturing of Liquid Dispersion of Wax

Preparation of Liquid Dispersion W-1 of Wax

A total of 180 parts of ester wax (WE-11, synthetic wax of plant-derived monomer, melting point of 67 degrees C., manufactured by NOF CORPORATION) and 17 parts of anionic surfactant (NEOGEN SC, sodium dodecylbenzenesulfonate, manufactured by DKS Co., Ltd.) were added to 720 parts of &ionized. water.

The resulting mixture was subjected to dispersion with a homogenizer to obtain liquid dispersion W-1 of wax while being heated to 90 degrees C. The volume average particle diameter of the wax particles obtained was 250 nm and the solid portion concentration of the resin particle was 25 percent.

Preparation of Liquid Dispersion W-2 of Wax

A total of 50 parts of paraffin wax (1-1NP-9, hydrocarbon wax, melting point of 75 degrees C., SP value of 8.8, manufactured by Nippon Seiro Co., Ltd.) and 450 parts of ethyl acetate were placed in a container equipped with a stirrer and a thermometer. While the mixture was being stirred, the system was heated to 80 degrees C. After maintaining the temperature at 80 degrees C., the system was cooled down to 30 degrees C. in an hour. The resulting mixture was subjected to dispersion by a bead mill (ULTRAVISCOMILL, manufactured by AIMEX) under conditions of a liquid transfer speed of 1 kg/hour, a disk peripheral speed of 6 mls, and a filling ratio of 0.5 mm zirconia beads of 80 percent by volume with three passes to obtain liquid dispersion W-2 of wax. The volume average particle diameter of the wax particles obtained was 350 nm and the solid portion concentration of the resin particle was 25 percent.

Preparation of Master Batch (MB)

A total of 1,200 parts of water, 500 parts of carbon black (Printer 35, manufactured by Degussa AG, DBP oil absorption amount of 42 in1/100 mg, PH of 9.5), and 500 parts of amorphous polyester resin B-i were admixed by a Henschel Mixer (manufactured by NIPPON COKE & ENGINEERING. CO., LTD.). The mixture was kneaded at 150 degrees C. for 30 minutes using two rolls and rolled and cooled down followed by pulverization hy a pulverizer to obtain a master batch.

Example 1

Preparation of Oil Phase

A total of 50 parts of prepolymer A-1, 200 parts of liquid dispersion W-2 of wax 0 containing 50 parts of solid portions, 250 parts of liquid dispersion C-3 of crystalline polyester resin containing 25 parts of solid portion. 800 parts of amorphous polyester resin B-4, and 50 parts of master hatch 1 were placed in a container and mixed hy a TK homomixer (manufactured by PRIMIX Corporation) at 5,000 rpm for 60 minutes to obtain oil phase 1.

The number of parts mentioned above represents the solid portion in each raw 5 material.

Preparation of Aqueous Phase

A total of 990 parts of water, 20 parts of sodium dodecyl sulfate, and 90 parts of ethyl acetate were mixed and stirred to obtain a milky white liquid. This liquid was determined as aqueous phase 1.

Emulsification

A total of 20 parts of 28 percent ammonium water was added to 700 parts of oil phase 1 while being stirred by a TK homomixer at a rate of rotation of 8,000 rpm. After mixing for 10 minutes, 1,200 parts of aqueous phase 1 was slowly added dropwise to the liquid mixture to obtain emulsified slurry 1.

Removal of Solvent

Emulsified slurry 1 was placed in a container equipped with a stirrer and a thermometer followed by purging the emulsified slurry 1 of the solvent at 30 degrees C. for 180 minutes to obtain solvent-purged slurry 1.

Aggregation

A total of 100 parts of a solution of 3 percent magnesium chloride was added dropwise to solvent-purged slurry 1 followed by a 5-minute stirring. The resulting mixture was heated to 60 degrees C. and 50 parts of sodium chloride was added when the particle diameter reached 5.0 wn to complete aggregation, .Aggregated slurry I was thus obtained,

Fusion

Aggregated slurry 1 was stirred and heated to 70 degrees C. Heated aggregated slurry 1 was cooled down when the average circularity reached a target of 0,957. Slurry dispersion 1 was thus obtained.

Rinsing and Drying

After 100 parts of slurry dispersion 1 was filtered under a reduced pressure.
(I): 100 parts of deionized water was added to filtered cake followed by mixing with a TK HOMO⁻MIXER at a rate of rotation of 12,000 rpm for 10 minutes;
(2): 100 parts of sodium hydroxide at 10 percent was added to the filtered cake obtained in (1) and the resulting mixture was mixed with a TK HOMOMIXER at 12,000 rpm for 30 minutes followed by filtering with under reduced pressure;
(3): 100 parts of hydrochloric acid at 10 percent was added to the filtered cake obtained in (2) and the resulting mixture was mixed with a TK 1-IOMOM1XER at 12,000 rpm for 10 minutes followed by filtering;
(4): 300 parts of deionized water was added to the filtered cake obtained in (3) and the resulting mixture was mixed with a TK HOMOMIXER at 12,000 rpm for 10 minutes followed by filtering operations of (1) to (4) mentioned above twice to obtain filtered cake 1; and

0 (5): filtered cake 1 was dried by a circulating drier at 45 degrees C. for 48 hours. The dried cake was sieved using a screen having an opening of 75 nm to obtain resin particle 1.

### Examples 2 to 9

Resin particles 2 to 9 were prepared in the same manner as in Example 1 for preparing resin particle 1 except that the type and the number of parts of the metal salt, prepolymer, wax, crystalline resin and amorphous resin added in the aggregation process were changed as shown in Table 1.

### Comparative Examples 1 to 5

Resin particles 10 to 13 of Comparative Examples 1 to 4 were prepared in the same manner as in Example 1 for preparing resin particle 1 except that the type and the number of parts of the metal salt, prepolymer, wax, crystalline resin and amorphous resin added in the aggregation process were changed as shown in Table 1.

In Comparative Example 5, resin particle 14 was obtained in the same manner as in Example 1 for preparing resin particle 1 except that HCl was added dropwise for aggregation without adding a metal salt.

The material compositions for preparing resins 1 to 14 are shown in Table 1.

The values of the degree of biomass of each component and resin particle of resin particle 1 to resin particle 14 were calculated and shown in Table 2 for reference. The calculated values do not necessarily match the actual values.

Treatment with External Additive

A total of 2.0 parts of an external additive, hydrophobic silica (HDK-2000, manufactured by Clariant AG), was added to and mixed with 100 parts of resin particle 1 in a

Henschel Mixer, followed by filtering with a screen having an opening of 500 meshes to obtain toner 1.

Resin particles 2 to 14 were subjected to the same external additive treatment as in resin particle 1 to obtain toners 2 to 14.

These toners were evaluated on filming, low temperature fixability, high temperature storage stability.

The results are shown in Table 3.

Evaluation Method

Compatibility to Environment 5 Compatibility to environment of the resin particle of each Example and Comparative

Examples was evaluated by measuring carbon-14 concentration thereof.

The carbon-14 concentration of resin particles is measured according to ASTM-D6866 format.

The resin particles were burnt to reduce carbondioxide (CO2) to obtain graphite (C). Carbon-14 concentration of graphite was measured by an Accelerator Mass Spectroscopy (AMS), manufactured by Beta Analytic.

The evaluation criteria are as follows:

Evaluation Criteria
S: 20 or greater
A: 15 to less than 20
B: S to less than 15
C: Less than 5

Photoconductor filming

A print pattern was printed on one sheet per job with a print ratio of 2 percent in a high temperature (27 degrees C.) and high humidity (80 percent) environment using a printer. imagio MP 05503, manufactured by Ricoh Co., Ltd. The pohtoconductor was visually checked per 10,000 prints. The evaluation criteria are as follows:

Evaluation Criteria
A: Free of filming on photoconductor for 200,000 prints
B: Filming occurs somewhere between from 80,000 to 150,000 prints.
C: Filming occurs before 70,000 prints.

Low Temperature Fixability

A developing agent was obtained by mixing the carrier for use in imagio MP C5503, manufactured by Ricoh Co., Ltd., with the resin particle obtained as described above to achieve a concentration of the resin particle of 5 percent by mass.

This developing agent was placed in the unit of imagio MP 05503, manufactured by Ricoh Co., Ltd. Then an oblong solid image of 2 cm x 15 cm was printed on PPC paper type 6000 <70W;>. A4 grain long (GL, manufactured by Ricoh Co., Ltd., with an amount of toner attached of 0.40 mg/cm². The image was printed by changing the surface temperature of the fixing roller to check whether the developed image of the solid image was fixed at a position other than the target portion, which is a phenomenon called cold offset, to evaluate the low temperature fixability.

Evaluation Criteria
A: less than 110
B: 110 to less than 125
C: 125 or higher

High Temperature Storage Stability

A glass container for evaluating the high temperature storage stability was filled with the toner obtained and was left in a. thermostatic chamber at 50 degrees C. for 24 hours.

This toner was then cooled down to 24 degrees C. and subjected to the penetration test according to JIS K2235-1991 format.

The evaluation criteria of the high temperature storage stability based on penetration is as follows.
Evaluation Criteria
A: 25 mm or greater
B: 10 to less than 25 mm
C: Less than 10 mm

TABLE 1

| | | | Type (amount of solid | | | |
|---|---|---|---|---|---|---|
| | | Metal | portion: parts) | | | |
| | | element | | | | |
| Example | Resin | Added | Prepolymer | | WAX | |
| No. | particle No. | metal salt | Type | Amount | Type | Amount |
| Example 1 | Resin | MgCl₂ | A-1 | 50 | W-2 | 50 |
| | particle 1 | | | | | |
| Example 2 | Resin | MgCl₂ | A-3 | 50 | W-2 | 50 |
| | particle 2 | | | | | |
| Example 3 | Resin | MgSO₄ | A-1 | 80 | W-2 | 50 |
| | particle 3 | | | | | |
| Example 4 | Resin | MgSO₄ | A-2 | 30 | W-2 | 50 |
| | particle 4 | | | | | |
| Example 5 | Resin | MgSO₄ | A-4 | 80 | W-2 | 50 |
| | particle 5 | | | | | |
| Example 6 | Resin | MgSO₄ | A-2 | 120 | W-2 | 50 |
| | particle 6 | | | | | |
| Example 7 | Resin | AlCl₃ | A-2 | 140 | W-1 | 50 |
| | particle 7 | | | | | |
| Example 8 | Resin | MgSO₄ | A-2 | 120 | W-1 | 50 |
| | particle 8 | | | | | |
| Example 9 | Resin | CaCl₂ | A-2 | 150 | W-1 | 50 |
| | particle 9 | | | | | |
| Comparative | Resin | MgCl₂ | A-1 | 50 | W-2 | 50 |
| Example 1 | particle 10 | | | | | |
| Comparative | Resin | MgCl₂ | a-2 | 80 | W-2 | 50 |
| Example 2 | particle 11 | | | | | |
| Comparative | Resin | MgCl₂ | a-3 | 80 | W-2 | 50 |
| Example 3 | particle 12 | | | | | |
| Comparative | Resin | MgCl₂ | a-1 | 80 | W-2 | 50 |
| Example 4 | particle 13 | | | | | |
| Comparative | Resin | pH | A-1 | 80 | W-2 | 50 |
| Example 5 | particle 14 | regulation | | | | |
| | | alone | | | | |

| | | | Type (amount of solid portion: parts) | | | | |
|---|---|---|---|---|---|---|---|
| | | | Crystalline | | Amorphous | | |
| Example | Resin | Metal element | polyester resin | | polyester resin | | MB |
| No. | particle No. | Added metal salt | Type | Amount | Type | Amount | Amount |
| Example 1 | Resin | MgCl₂ | C-3 | 25 | B-4 | 800 | 50 |
| | particle 1 | | | | | | |
| Example 2 | Resin | MgCl₂ | C-3 | 25 | B-4 | 800 | 50 |
| | particle 2 | | | | | | |
| Example 3 | Resin | MgSO₄ | C-3 | 50 | B-2 | 770 | 50 |
| | particle 3 | | | | | | |
| Example 4 | Resin | MgSO₄ | C-3 | 50 | B-2 | 770 | 50 |
| | particle 4 | | | | | | |
| Example 5 | Resin | MgSO₄ | C-3 | 50 | B-2 | 770 | 50 |
| | particle 5 | | | | | | |
| Example 6 | Resin | MgSO₄ | C-3 | 50 | B-2 | 730 | 50 |
| | particle 6 | | | | | | |
| Example 7 | Resin | AlCl₃ | C-2 | 50 | B-1 | 710 | 50 |
| | particle 7 | | | | | | |
| Example 8 | Resin | MgSO₄ | C-2 | 50 | B-1 | 730 | 50 |
| | particle 8 | | | | | | |
| Example 9 | Resin | CaCl₂ | C-1 | 50 | B-1 | 700 | 50 |
| | particle 9 | | | | | | |
| Comparative | Resin | MgCl₂ | C-3 | 50 | B-4 | 800 | 50 |
| Example 1 | particle 10 | | | | | | |
| Comparative | Resin | MgCl₂ | C-3 | 50 | B-2 | 770 | 50 |
| Example 2 | particle 11 | | | | | | |
| Comparative | Resin | MgCl₂ | C-3 | 50 | B-2 | 770 | 50 |
| Example 3 | particle 12 | | | | | | |
| Comparative | Resin | MgCl₂ | C-3 | 50 | B-2 | 770 | 50 |
| Example 4 | particle 13 | | | | | | |
| Comparative | Resin | pH regulation | C-3 | 50 | B-2 | 770 | 50 |
| Example 5 | particle 14 | alone | | | | | |

TABLE 2

| | | | | | | Degree of biomass |
|---|---|---|---|---|---|---|
| | | | | | | (percent) of |
| | Degree of biomass (percent) of each component | | | | | resin particle |
| Resin | | | Crystalline | Amorphous | | (calculation value) |
| particle No. | Prepolymer | WAX | resin | resin | MB | Total |
| Resin | 0 | 0 | 52.6 | 3.9 | 14.8 | 5.3 |
| particle 1 | | | | | | |
| Resin | 0 | 0 | 52.6 | 3.9 | 14.8 | 5.3 |
| particle 2 | | | | | | |
| Resin | 0 | 0 | 0 | 16.9 | 14.8 | 13.8 |
| particle 3 | | | | | | |
| Resin | 0 | 0 | 0 | 16.9 | 14.8 | 14.5 |
| particle 4 | | | | | | |
| Resin | 0 | 0 | 0 | 16.9 | 14.8 | 13.8 |
| particle 5 | | | | | | |
| Resin | 0 | 0 | 0 | 29.6 | 14.8 | 22.3 |
| particle 6 | | | | | | |
| Resin | 100 | 100 | 52.6 | 29.6 | 14.8 | 43.4 |
| particle 7 | | | | | | |
| Resin | 100 | 100 | 52.6 | 29.6 | 14.8 | 42.0 |
| particle 8 | | | | | | |
| Resin | 100 | 100 | 100 | 29.6 | 14.8 | 46.5 |
| particle 9 | | | | | | |
| Resin | 0 | 0 | 0 | 3.9 | 14.8 | 3.9 |
| particle 10 | | | | | | |
| Resin | 0 | 0 | 0 | 16.9 | 14.8 | 13.8 |
| particle 11 | | | | | | |
| Resin | 0 | 0 | 0 | 16.9 | 14.8 | 13.8 |
| particle 12 | | | | | | |
| Resin | 0 | 0 | 0 | 16.9 | 14.8 | 13.8 |
| particle 13 | | | | | | |
| Resin | 0 | 0 | 0 | 16.9 | 14.8 | 13.8 |
| particle 14 | | | | | | |

TABLE 3

| | | | | THF insoluble portion | | |
|---|---|---|---|---|---|---|
| | | | Carbon 14 | Amount | Tg | Metal |
| | Resin | | concentration | (percent | (degrees | element |
| | particle | Toner | (pMC) | by mass) | C.) | contained |
| Example 1 | Resin | Toner 1 | 5.5 | 17 | −36.2 | Mg |
| | particle 1 | | | | | |
| Example 2 | Resin | Toner 2 | 5.5 | 17 | −59.7 | Mg |
| | particle 2 | | | | | |
| Example 3 | Resin | Toner 3 | 14.8 | 21 | −35.8 | Mg |
| | particle 3 | | | | | |
| Example 4 | Resin | Toner 4 | 15.5 | 14 | −38.7 | Mg |
| | particle 4 | | | | | |
| Example 5 | Resin | Toner 5 | 14.8 | 21 | −0.5 | Mg |
| | particle 5 | | | | | |
| Example 6 | Resin | Toner 6 | 23.0 | 28 | −38.9 | Mg |
| | particle 6 | | | | | |
| Example 7 | Resin | Toner 7 | 45 | 36 | −38.4 | Al |
| | particle 7 | | | | | |
| Example 8 | Resin | Toner 8 | 44 | 29 | −38.6 | Al |
| | particle 8 | | | | | |
| Example 9 | Resin | Toner 9 | 50.2 | 34 | −38.7 | Ca |
| | particle 9 | | | | | |
| Comparative | Resin | Toner 10 | 4.2 | 17 | −36.4 | Mg |
| Example 1 | particle 10 | | | | | |
| Comparative | Resin | Toner 11 | 14.7 | 21 | −38.8 | Mg |
| Example 2 | particle 11 | | | | | |
| Comparative | Resin | Toner 12 | 14.6 | 17 | −65 | Mg |
| Example 3 | particle 12 | | | | | |
| Comparative | Resin | Toner 13 | 14.7 | 2 | −37 | Mg |
| Example 4 | particle 13 | | | | | |
| Comparative | Resin | Toner 14 | 14.8 | 2 | −36.1 | Undetected |
| Example 5 | particle 14 | | | | | |

| | | | | Evaluation result | |
|---|---|---|---|---|---|
| | | | Carbon 14 | Compatibility | |
| | Resin | | concentration | to | Photoconductor |
| | particle | Toner | (pMC) | environment | filming |
| Example 1 | Resin | Toner 1 | 5.5 | B | A |
| | particle 1 | | | | |
| Example 2 | Resin | Toner 2 | 5.5 | B | A |
| | particle 2 | | | | |
| Example 3 | Resin | Toner 3 | 14.8 | A | A |
| | particle 3 | | | | |
| Example 4 | Resin | Toner 4 | 15.5 | A | B |
| | particle 4 | | | | |
| Example 5 | Resin | Toner 5 | 14.8 | A | A |
| | particle 5 | | | | |
| Example 6 | Resin | Toner 6 | 23.0 | S | A |
| | particle 6 | | | | |
| Example 7 | Resin | Toner 7 | 45 | S | A |
| | particle 7 | | | | |
| Example 8 | Resin | Toner 8 | 44 | S | A |
| | particle 8 | | | | |
| Example 9 | Resin | Toner 9 | 50.2 | S | B |
| | particle 9 | | | | |
| Comparative | Resin | Toner 10 | 4.2 | C | A |
| Example 1 | particle 10 | | | | |
| Comparative | Resin | Toner 11 | 14.7 | A | C |
| Example 2 | particle 11 | | | | |
| Comparative | Resin | Toner 12 | 14.6 | A | C |
| Example 3 | particle 12 | | | | |
| Comparative | Resin | Toner 13 | 14.7 | A | C |
| Example 4 | particle 13 | | | | |
| Comparative | Resin | Toner 14 | 14.8 | A | C |
| Example 5 | particle 14 | | | | |

| | | | | Evaluation result | |
|---|---|---|---|---|---|
| | | | | | High |
| | | | Carbon 14 | Low | temperature |
| | Resin | | concentration | temperature | storage |
| | particle | Toner | (pMC) | fixability | stability |
| Example 1 | Resin | Toner 1 | 5.5 | A | A |
| | particle 1 | | | | |
| Example 2 | Resin | Toner 2 | 5.5 | A | A |
| | particle 2 | | | | |
| Example 3 | Resin | Toner 3 | 14.8 | A | A |
| | particle 3 | | | | |
| Example 4 | Resin | Toner 4 | 15.5 | A | A |
| | particle 4 | | | | |
| Example 5 | Resin | Toner 5 | 14.8 | A | A |
| | particle 5 | | | | |
| Example 6 | Resin | Toner 6 | 23.0 | A | A |
| | particle 6 | | | | |
| Example 7 | Resin | Toner 7 | 45 | B | A |
| | particle 7 | | | | |
| Example 8 | Resin | Toner 8 | 44 | A | A |
| | particle 8 | | | | |
| Example 9 | Resin | Toner 9 | 50.2 | A | A |
| | particle 9 | | | | |
| Comparative | Resin | Toner 10 | 4.2 | A | A |
| Example 1 | particle 10 | | | | |
| Comparative | Resin | Toner 11 | 14.7 | A | C |
| Example 2 | particle 11 | | | | |
| Comparative | Resin | Toner 12 | 14.6 | A | C |
| Example 3 | particle 12 | | | | |
| Comparative | Resin | Toner 13 | 14.7 | A | A |
| Example 4 | particle 13 | | | | |
| Comparative | Resin | Toner 14 | 14.8 | A | A |
| Example 5 | particle 14 | | | | |

The present disclosure is related to the resin particle of the following 1 and also includes the following 2 to 7 as embodiments.

1. A resin particle contains resin containing a tetrahydrofuran insoluble portion containing a non-linear polymer in which a non-linear prepolymer is cross-linked with a metal ion, wherein the resin particle has a carbon-14 concentration of 5.4 pMC or greater, wherein the tetrahydrofuran insoluble portion has a glass transition temperature of from −60 to lower than 0 degrees C. as measured by differential scanning calorimetry.

2. The resin particle according to 1 mentioned above, wherein the resin particle has a carbon-14 concentration of 10.8 pIVIC or greater. 3. The resin particle according to 1 or 2 mentioned above, wherein the resin contains polyester resin.

4. The resin particle according to any one of 1 to 3 mentioned above, wherein the proportion of the THF insoluble portion to the resin particle is from 15 to 40 parts by mass.

5. The resin particle according to any one of 1 to 4 mentioned above, wherein the metal ion contains a di- or higher valent metal ion.

6. A toner contains the resin particle of any one of 1 to 5.

7. A toner acconimodating unit includes a container containing the toner of 6 mentioned above.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A resin particle comprising:
resin comprising a tetrahydrofuran insoluble portion comprising a non-linear polymer in which a non-linear prepolymer is cross-linked with a metal ion,
wherein the resin particle has a carbon-14 concentration of 5.4 pMC or greater,
wherein the tetrahydrofuran insoluble portion has a glass transition temperature of from −60 to lower than 0 degrees C. as measured by differential scanning calorimetry.

2. The resin particle according to claim I, wherein the resin particle has a carbon-14 concentration of 10.8 pMC or greater.

3. The resin particle according to claim 1, wherein the resin comprises polyester resin.

4. The resin particle according to claim 1,
wherein a proportion of the tetrahydrofuran insoluble portion to the resin particle is from 15 to 40 percent by mass.

5. The resin particle according to claim 1, wherein the metal ion comprises a di- or 0 higher valent metal ion.

6. A toner comprising:
the resin particle of claim 1.
7. A toner accommodating unit comprising:
a container containing the toner of claim 6.
